(19) United States
(12) Patent Application Publication
(10) Pub. No.: US 2008/0229649 A1
(43) Pub. Date: Sep. 25, 2008

(54) Fishing Lure and Method of Manufacturing a Fishing Lure

(75) Inventors: Timothy G. Smith, St. Marys, PA (US); Ivan R. Smith, St. Marys, PA (US)

Correspondence Address: THE WEBB LAW FIRM, P.C., 700 KOPPERS BUILDING, 436 SEVENTH AVENUE, PITTSBURGH, PA, 15219, US

(73) Assignee: CONTINUOUS METAL TECHNOLOGY INC., Ridgway, PA (US)

(21) Appl. No.: 12/051,293

(22) Filed: Mar. 19, 2008

Related U.S. Application Data
(60) Provisional application No. 60/918,831, filed on Mar. 19, 2007.
(60) Provisional application No. 60/931,363, filed on May 23, 2007.

(51) Int. Cl. A01K 85/00; B23P 17/04

(52) U.S. Cl. 43/42.45; 29/592

(57) ABSTRACT

A fishing lure manufactured from a sintered metal powder. The metal powder may be one or more metals, one or more alloys, or any combination or mixture thereof. The lure is of a weight sufficient to sink to a depth in the water and shaped such that, when urged through the water, the lure moves in a substantially oscillating motion. A method of manufacturing a fishing lure is also disclosed.

### CROSS REFERENCE TO RELATED APPLICATIONS

This application claims the benefit of priority of U.S. Provisional Patent Application Nos. 60/918,831, filed Mar. 19, 2007 and 60/931,363, filed May 23, 2007, which are incorporated herein by reference in their entirety.

### BACKGROUND OF THE INVENTION

1. Field of the Invention

The present invention relates general to fishing tackle and, in particular, to a lure for use in fishing, as well as a method of manufacturing a fishing lure.

2. Description of the Related Art

Fishing is a popular hobby and sport, and increasing the chances of successfully landing a fish is dependent primarily upon the technique of the angler, and the type and operation of the tackle used. Specifically, in order to catch a fish, the appropriate bait, line, hooks, etc. should be used, and if the angler decides against using live bait, the most appropriate lure should be used. There is a variety of differing shapes, styles and functioning of fishing lures, which are all designed to attract specific types of fish to bite or “hit” the lure (i.e., the hook). Therefore, it is of paramount importance that the lure be as lifelike as possible when trolled or urged through the water. In addition, it is important that the lure be trolled through the water at the appropriate depth in order to attract the target fish.

According to the prior art, lures that appear to have fishlike movements in the water are manufactured from or carved from wood or some similar synthetic material, e.g., plastics, polymers, etc. While such lures mimic the realistic movements of a small fish, they require the addition of extra weight on the fishing line or lure in order to obtain the action and depth to reach the targeted fish. Further, and according to the prior art, lures also are manufactured to appear like a fish and cause similar reflections of light as a live fish traveling through the water. For example, spoons and other metal lures are mass manufactured and rely upon the flashing, coloring or extra skirting to entice the fish to engage the lure.

Another example of an artificial fish-baiting lure arrangement is the odoriferous fishing device of U.S. Pat. No. 3,953,934 to Visser. This device works in conjunction with a lure, in this case a worm, which has multiple hooks extending from a surface thereof. The device is a sintered, metal body and must be used together with a lure portion. In particular, the device of the Visser patent includes interconnected pores filled with a fish attractant, which is released into the water from the pores in a uniform, slow rate to attract fish to the hooks on the lure. However, this device is not a lure, and instead must be used together with some other luring member, e.g., an artificial worm, fish, minnow, etc. Further, the device of the Visser patent is aerodynamically designed to eliminate movement in the water, and instead to move in front of the lure and release a scent in the water.

As seen above, there is considerable room for improvement in the area of fishing tackle and lure design. In particular, there is a need for a fishing lure that moves in a lifelike manner in the water, and is capable of effectively submersing to the appropriate level without additional components. There is also a need for a fishing lure that attracts the fish in use, whether by movement or reflective light (and vision).

### SUMMARY OF THE INVENTION

It is, therefore, one object of the present invention to provide a fishing lure that overcomes the drawbacks and deficiencies of the prior art. It is another object of the present invention to provide a fishing lure that moves in a lifelike manner when under water. It is a further object of the present invention to provide a fishing lure that is an appropriate weight to descend under water to the location of the target fish. It is a still further object of the present invention to provide a fishing lure that reflects light in a manner similar to a live fish. It is yet another object of the present invention to provide a fishing lure that does not require additional components to operate and function in the desired lifelike manner.

Accordingly, the present invention is directed a fishing lure manufactured from a sintered metal powder, which is made up of one or more metals, alloys, etc. The fishing lure has a weight sufficient to sink to a depth in water. Further, the fishing lure is shaped such that, when urged through the water, the fishing lure moves in a substantially oscillating (or fish-like) motion.

In another aspect, the present invention is directed to a method of manufacturing a fishing lure. This method includes: filling a mold with metal powder; applying pressure to the metal powder in the mold, thereby providing a compacted form; and sintering the compact form under specified processing parameters, thereby forming the fishing lure. In one embodiment, the specified processing parameters include at least one of the following: sintering time, sintering temperature, sintering pressure, atmospheric conditions or any combination thereof.

In a still further aspect of the present invention, provided is a fishing lure manufactured from a sintered metal powder mixture that includes one or more metals, alloys, etc. The fishing lure includes a body having a first side surface, a second side surface and an edge surface. The first side surface, the second side surface and/or the edge surface includes one or more undulations sufficient to cause the lure to move in a substantially oscillating motion when urged through the water. Further, the fishing lure has a weight sufficient to sink to a depth in water.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a side view of one embodiment of a fishing lure manufactured in accordance with the principles of the present invention;

FIG. 2 is an edge view of the fishing lure of FIG. 1;

FIG. 3 is a perspective view of the fishing lure of FIG. 1;

FIG. 4 is a side view of another embodiment of a fishing lure manufactured in accordance with the principles of the present invention;

FIG. 5 is a side view of a further embodiment of a fishing lure manufactured in accordance with the principles of the present invention;

FIG. 6 is a side view of a still further embodiment of a fishing lure manufactured in accordance with the principles of the present invention; and

FIG. 7 is a perspective view of another embodiment of a fishing lure manufactured in accordance with the principles of the present invention.

### DETAILED DESCRIPTION OF THE PREFERRED EMBODIMENTS

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

It is to be understood that the invention may assume various alternative variations and step sequences, except where expressly specified to the contrary. It is also to be understood that the specific devices and processes illustrated in the attached drawings, and described in the following specification, are simply exemplary embodiments of the invention.

The present invention is directed to a fishing lure 10, as illustrated in various views and embodiments in FIGS. 1-7. In addition, the present invention is directed to a method of manufacturing a fishing lure 10. As discussed above, one of the drawbacks of the prior art is the inability of lures to move in a lifelike, i.e., “fish-like” manner, appear like live fish to the target fish and descend to the appropriate level or depth in the water. As discussed hereinafter, one or more of the preferred and non-limiting embodiments of the present invention overcome some or all of these drawbacks.

In order to manufacture the fishing lure 10 of the present invention, the first step is to provide or obtain a metal powder, which may be in the form of a metal powder mixture. While this metal powder or metal powder mixture may include a single type of metal, in one preferred and non-limiting embodiment, it is a mixture of various types of metals or alloys of these metals. For example, these metals may be iron, copper, nickel, chromium, tin, zinc, molybdenum, magnesium, tungsten, aluminum or any combination, mixtures or alloys thereof, and the alloys may be brass, bronze, stainless steel, carbon steel, etc. In particular, all of the above-mentioned metals and alloys can be obtained in a powdered form.

Once the powdered metal material is obtained, this material or mixture is placed in an appropriately sized and shaped mold. Such molds are well known in the art. Further, the mold would include an appropriate inner cavity to form the fishing lure 10 in a desired shape that leads to the oscillating fish-like motion, such as the shape illustrated in FIGS. 1-7. Once the mixture is placed in the mold, pressure is applied to the metal powder in order to compact this mixture. In one preferred and non-limiting embodiment, the applied pressure is in the range of about 10 to about 60 tons per square inch. Such pressure results in a “green” or un-sintered, compacted form of the lure 10.

It should be noted that the un-sintered compacted form of the lure 10 can be produced through an injection molding method, wherein the metal powder is injected into the mold cavity and is compacted through the injection process, or through a mechanical die compaction method, wherein the metal powder is compacted by applying pressure to die components surrounding the metal powder. In either method, a compacted form of the lure 10 is produced. In addition, and dependent upon the molding method utilized, certain additives may be used to facilitate the molding process. For example, the metal powder may be a metal powder mixture that contains a lubricant or binding agent to facilitate the injection molding or mechanical compaction processes. The lubricant may be a wax- or polymer-based material.

Next, in one preferred and non-limiting embodiment, the compacted form is debound in a de-binding process. This processing step can be used to remove the lubricant or binding agent prior to sintering, or alternatively, these materials can be removed at a point during the sintering process (as discussed hereinafter). Next, this compacted form is sintered and results in the sintered fishing lure 10 of the present invention. Further, the de-binding and sintering processes may be accomplished in a known continuous processing system.

In one preferred and non-limiting embodiment, the sintering occurs at a temperature between about 1,000° F. to about 2,800° F. and for a time period between about 20 minutes and about 180 minutes. Further, sintering may occur in a furnace configured to exhibit certain atmospheric conditions, e.g., an inert atmosphere, a reducing atmosphere, a vacuum, nitrogen, hydrogen, etc. Still further, after sintering, the formed fishing lure 10 may have a density of about 70% to about 99% the theoretical density of the starting material, i.e., the metal powder.

In one example of the method of manufacturing the fishing lure 10 of the present invention, the mold is filled in a dual-action press, and the powdered mixture is a standard 316 stainless steel powder, which includes 15-18% by weight chromium, 10-14% by weight nickel, 2-3% by weight molybdenum, 0.5-1.25% by weight lithium stearate (as a lubricant) and the balance iron. Upper and lower punches are compacted to 40 tons per square inch. The resulting “green” form is placed in a continuous sintering furnace, such as a two-zone CI Hayes 8-inch pusher furnace. The furnace includes a first (de-binding) zone set at about 1,400° F. for about 30 minutes, and a second (sintering) zone set at about 2,350° F., also for about 30 minutes. The atmosphere of the furnace includes nitrogen and hydrogen. According to this embodiment, the resulting sintered form and fishing lure 10 is a 6.6 gram per cubic centimeter dense, stainless steel lure 10.

While discussed in connection with a compacted or “green” form, it is also envisioned that this “green” or intermediate (compacted) form is manufactured in a variety of manners. For example, this intermediate form may be created in an injection molding process, and subsequently sintered (as discussed above). Other processes to create and provide this pre-sintered form may be used within the context of the present invention.

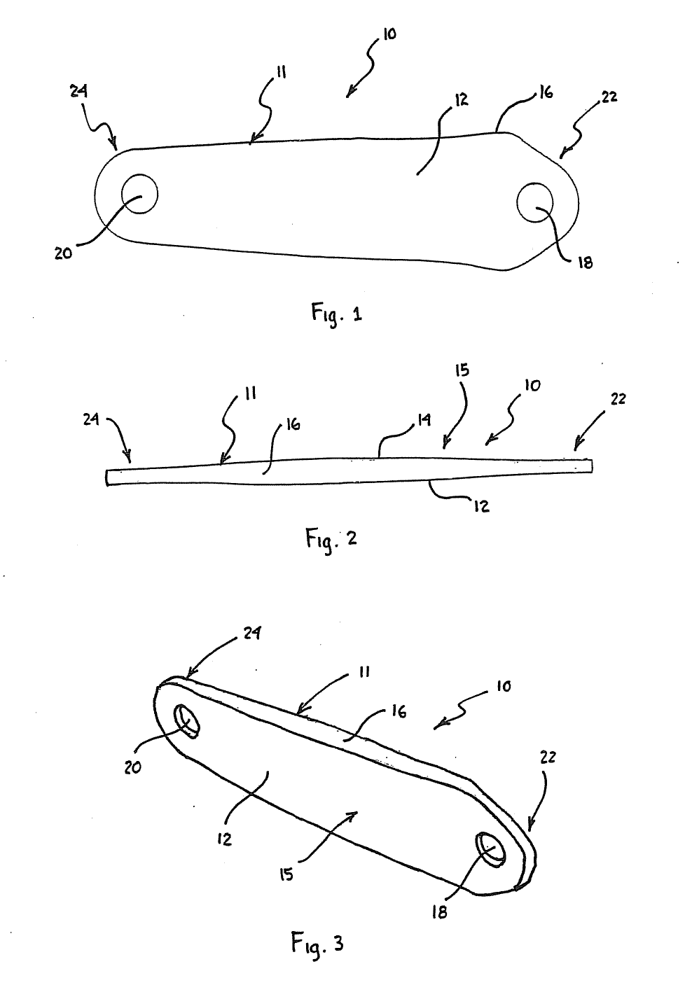

One preferred and non-limiting embodiment of the shape of the lure 10 is illustrated in FIGS. 1-6. With specific reference to FIGS. 1-6, the lure 10 includes a body 11 having a first side surface 12, a second side surface 14 and an edge surface 16. In addition, and as best illustrated in FIG. 2, each of the first side surface 12 and the second side surface 14 includes specific undulations 15 and/or relative depths and curvature, which mimic the shape of a fish. In addition, and based upon the shape of the side surfaces 12, 14 (or the edge surface 16), when the lure 10 is submerged and subsequently urged or pulled through the water, it moves in an oscillating or back-and-forth (fish-like) motion. Accordingly, the mold used to form the lure 10 includes an inner cavity that imparts these undulations and differentiating thicknesses upon the surfaces 12, 14 of the lure 10. In addition, and as best seen in FIG. 1, the edge surface 16 is also formed in a generally fish-like shape, which is also accomplished through the shape of the inner cavity of the mold, and may also serve to impart certain motion characteristics upon the lure 10 during operation and use.

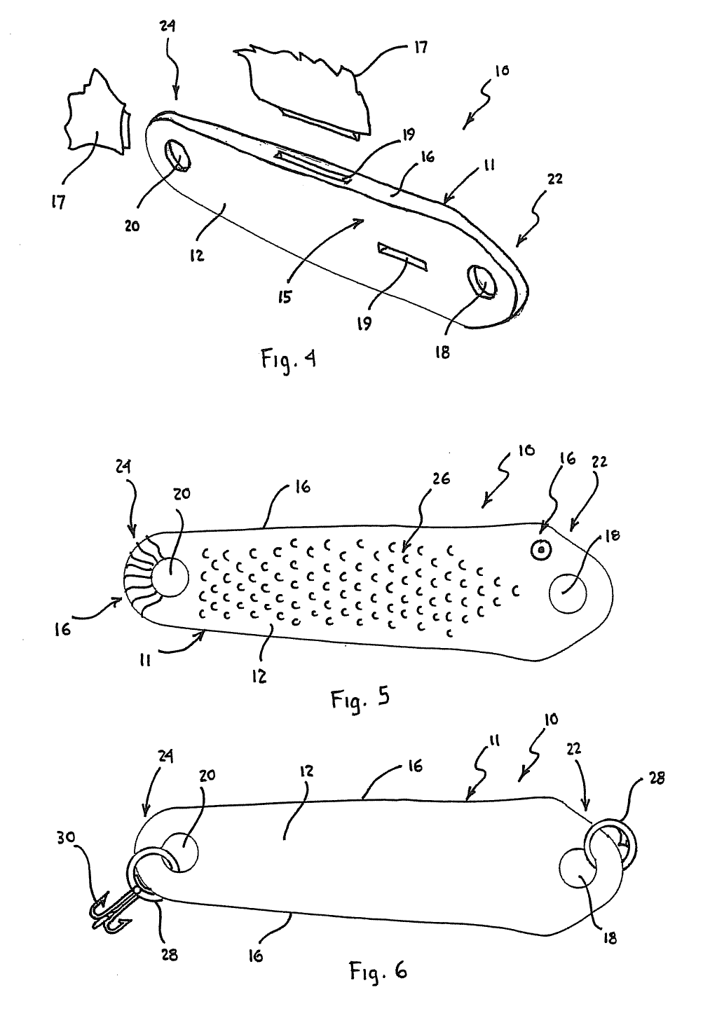

In another preferred and non-limiting embodiment, fins may be added to the body 11 during the molding process, as based upon the shape of the mold. However, and as illustrated in FIG. 4, prefabricated fins 17 can be attached or otherwise coupled to the body 11 after the sintering process is complete, or even by the consumer prior to use. As seen in the exemplary embodiment of FIG. 4, these fins 17 can be pressed into engagement within one or more slots 19 formed on the surfaces 12, 14, 16 of the body 11. These fins 17 can be decorative, in order to allow the lure 10 to appear more fish-like to the target fish, and, dependent upon shape and design, may further assist in imparting the oscillating motion that primarily occurs as a result of the shape of the body 11 itself. A variety of types, colors, shapes and sizes of fins 17 can be used in an interchangeable manner with the slots 19 on the body 11 dependent upon the user's experience or understanding of the target fish.

As illustrated in FIG. 5, and in another preferred and non-limiting embodiment, in order to provide for the attachment of other elements to the lure 10, a first orifice 18 extends through a first end 22 of the body 11 of the lure 10, and a second orifice 20 extends through a second end 24 of the body 11 of the lure 10. In operation, the first orifice 18 is at the “eye” end of the body 11 of the lure 10, while the second orifice 20 is positioned at the “tail” end of the body 11 of the lure 10. These orifices 18, 20 may be formed during the molding process, or alternatively punched through the form (or lure 10) during or after the compacting, de-binding and/or sintering processes.

In another preferred and non-limiting embodiment, and as also illustrated in FIG. 5, the surfaces 12, 14, 16 may also include additional design aspects and features. In particular, fish-like design elements 26 may be appropriately positioned or created on the first side surface 12 and/or the second side surface 14. Further, these design elements 26 may be representative or in the appearance of scales, fins, eyes, mouth, etc. Accordingly, by using these design elements 26, not only does the lure 10 look more lifelike to the target fish, it also will reflect light in a more lifelike manner. Such reflection also occurs due to the “metallic” nature of the lure 10.

The design elements 26 may be disposed or created on the first side surface 12 and/or the second side surface 14 in a variety of manners. For example, the design elements 26 may be created during the manufacturing process discussed above, such as through the use of the mold and elements of the mold that provide the undulations 15, curved features, relative thicknesses on the lure 10. However, as with the orifices 18, 20 and, in some embodiments, the slots 19, the design elements 26 may also be applied to the side surfaces 12, 14 after the compacting, de-binding and sintering processes. Specifically, these design elements 26 may be etched or otherwise applied to the surfaces 12, 14 in a later stage of manufacturing, or even by the user of the lure 10 after purchase.

In a further preferred and non-limiting embodiment, and as illustrated in FIG. 6, various appurtenances and components can be attached directly to the lure 10, e.g., via the orifices 18, 20, or indirectly to the lure 10, e.g., via other attaching arrangements. For example, as shown in FIG. 6, a discontinuous loop (normally made of metal) 28 (e.g., a key-ring arrangement) may be attached to the first orifice 18 and/or the second orifice 20. In this manner, the angler may attach the fishing line (not shown) to the loop 28 attached through the first orifice 18 (or the “eye” end of the body 11 of the lure 10), while a loop 28 may also be attached to the second orifice 20 of the lure 10 (or the “tail” end of the body 11 of the lure 10). Further, a hook 30 may be attached to the loop 28 positioned at the second orifice 20 of the lure 10. Of course, any fishing components or items may be attached to lure 10 by the user and by using these loops 28.

In a still further preferred and non-limiting embodiment, the lure 10 may be manufactured to obtain a specified porosity. Accordingly, and through the manufacturing process, the porosity is capable of being controlled. The powdered metal process is one in which the density/porosity of the finished part can be utilized in providing additional fish attractant mechanisms and functions. In general, the density/porosity is controlled by means of powder type, powder size and shape selection, compaction pressure, and/or sintering conditions, etc.

The body 11 of the lure 10 can be injected or impregnated with a scent-enhancing or fish attracting material, e.g., a liquid material. This liquid material can be placed into the body 11 of the lure 10 by a number of methods, including (but not limited to): vacuum impregnation (covering the lure 10 in the attractant, and then drawing a vacuum); heating the lure 10, and then soaking it in the attractant; directly injecting or forcing the fish attracting material into the body 11 of the lure 10; and/or some prolonged soaking period, where the material penetrates the pores of the body 11.

Fish attractants generally have a base of fish oil with differing pungent scent enhancers added. Any such commercially-available or self-created attractants may be used in connection with the lure 10 of the present invention. Further, these attractants may differ depending upon the target fish. One major drawback in the use of an attractant on today's fully-dense spoons and plastic lures is that the attractant washes off in the water, as it is being used. The ability of the presently-invented lure 10 to be impregnated with a fish attracting material allows the scent to stay with the bait through multiple uses.

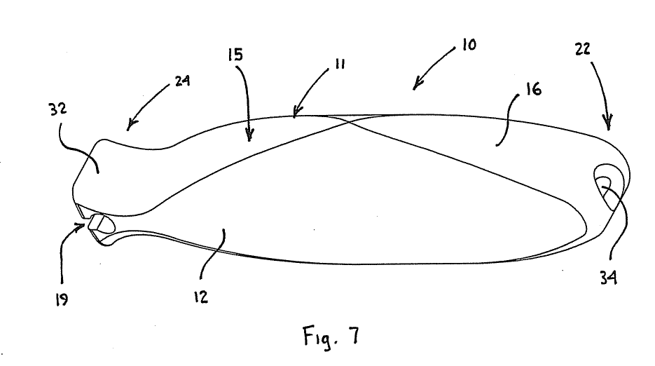

A still further preferred and non-limiting embodiment of the lure 10 of the present invention is illustrated in FIG. 7. As discussed above in connection with the previous embodiments, the lure 10 of this embodiment is formed into a shape that provides the oscillating motion when pushed, pulled or urged through the water. As demonstrated in FIG. 7, the lure 10 is formed in a more “fish-like” shape with the appropriate undulations 15 and/or curvature on the side surfaces 12, 14 and the edge surface 16, which lead to this oscillating movement. Further, a tail portion 32 is formed near the second end 24 of the body 11. Based upon the shape of this tail portion 32 and the overall “fish-like” shape of the body 11, the lure 10 of this embodiment provides a more realistic and “baiting” or attractive shape to the target fish.

In addition, in this embodiment, a central bore 34 extends from the first end 22 (or “head” end) of the lure 10 through the body 11 and to the second end 24 (or “tail” end) of the lure 10. In operation, the fishing line (not shown) can be fed through this bore 34 at the first end 22 and either attached to a hook 30 at the second end 24, or alternatively, attached to the second end 24 or tail portion 32 of the lure 10. Still further, in this embodiment, a slot 19 is formed at the second end 24 at the tail portion 32, such that the fishing line can be attached around side surfaces 12, 14 and/or edge surface 16 of the lure 10 in the area surrounding the slot 19. Of course, and as discussed above, the slot 19 may be used to attach other components to the lure 10. In one method of manufacturing the shape of the body 11 of the lure 10 of this embodiment, the above-discussed injection molding process is used to obtain the “green” or compacted form of the lure 10 prior to sintering.

In this manner, and due to the shape of the lure 10 of the present invention, the lure 10 moves in an oscillating or back-and-forth motion through the water in a lifelike manner. Still further, due to the manufacturing method discussed above, and by using the sintered metal powder material, the resultant lure 10 exhibits the appropriate weight characteristics to descend into the water to the target fish location, without the requirement of additional weights attached thereto. Since the lure 10 does not require additional weights attached thereto, it assumes the shape of a real fish, which increases the chances that the target fish will “hit” the lure 10. Still further, and in some embodiments, by applying the appropriate design elements 26, together with the metallic finish of the lure 10, the lure 10 exhibits the appropriate reflective characteristics, which also provide a more lifelike appearance to the target fish. Still further, the lure 10 of the present invention is in a form that permits the user to add other features to the lure 10, e.g., fins 17, design elements 26, etc., which permits the user to be in control of how to tailor and create the most useful and successful lure 10. In this manner, and by using the inventive process, a lure 10 is provided that appears and acts in a lifelike manner, and descends to the appropriate depth to the target fish location.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A fishing lure manufactured from a sintered metal powder comprising at least one of the following: at least one metal, at least one alloy or any combination or mixture thereof, wherein the fishing lure has a weight sufficient to sink to a depth in water, and wherein the fishing lure is shaped such that, when urged through the water, the fishing lure moves in a substantially oscillating motion.

2. The fishing lure of claim 1, further comprising a body having a first side surface, a second side surface and an edge surface, wherein at least one of the first side surface, the second side surface and the edge surface comprises at least one undulation sufficient to cause the fishing lure to move in the substantially oscillating motion.

3. The fishing lure of claim 2, further comprising at least one orifice or bore extending through the body and sized and shaped for the attachment of at least one of the following: at least one discontinuous loop of metal, a fishing line, at least one fishing hook, a fishing component or any combination thereof.

4. The fishing lure of claim 3, further comprising:
a first orifice extending through a first end of the fishing lure;
a second orifice extending through a second end of the fishing lure; and
a discontinuous loop of metal attached through at least one of the first orifice and the second orifice.

5. The fishing lure of claim 2, further comprising at least one design on at least a portion of at least one surface of the body, wherein the design is formed to represent at least one of the following: scales, eyes, mouth, a fish body part or any combination thereof.

6. The fishing lure of claim 2, further comprising at least one slot extending at least partially within at least a portion of at least one surface of the body, wherein the slot is sized and shaped so as to at least partially engage a prefabricated, artificial fin therein.

7. The fishing lure of claim 1, wherein the fishing lure is at least partially impregnated or injected with, or soaked in, a fish attracting material.

8. A method of manufacturing a fishing lure, comprising the steps of:
filling a mold with metal powder;
applying pressure to the metal powder in the mold, thereby providing a compacted form; and
sintering the compacted form under specified processing parameters, thereby forming the fishing lure.

9. The method of claim 8, wherein the specified processing parameters include at least one of the following: sintering time, sintering temperature, sintering pressure, atmospheric conditions or any combination thereof.

10. The method of claim 8, wherein the metal powder comprises at least one of the following: at least one metal, at least one alloy, at least one lubricant, at least one binding agent, at least one wax-based material, at least one polymer-based material or any combination or mixture thereof.

11. The method of claim 10, wherein the metal powder comprises at least one metal, and the metal is at least one of the following: iron, copper, nickel, chromium, tin, zinc, molybdenum, magnesium, tungsten, aluminum.

12. The method of claim 10, wherein the metal powder comprises at least one alloy, and the alloy is at least one of the following: brass, bronze, stainless steel, carbon steel.

13. The method of claim 8, wherein, after compacting and prior to sintering, the method further comprises at least partially de-binding the compacted metal powder.

14. The method of claim 8, wherein the pressure applied to the metal powder is from about 10 tons per square inch to about 60 tons per square inch.

15. The method of claim 8, wherein the metal powder comprises a stainless steel powder mixture including chromium, nickel and molybdenum.

16. The method of claim 8, wherein the sintering occurs at a temperature between about 1,000° F. to about 2,800° F. and for a time period between about 20 minutes and about 180 minutes.

17. The method of claim 8, wherein the sintering occurs in a furnace having atmospheric conditions including at least one of the following: an inert atmosphere, a reducing atmosphere, a vacuum, nitrogen and hydrogen.

18. The method of claim 8, wherein, after sintering, the formed fishing lure has a density of about 70% to about 99% of the theoretical density of the metal powder.

19. The method of claim 8, further comprising forming at least one design on at least one surface of the fishing lure, the design formed to represent at least one of the following: scales, eyes, mouth, a fish body part or any combination thereof.

20. The method of claim 8, wherein the mold is sized and shaped so as to form at least one surface of the fishing lure with at least one undulation sufficient to cause the lure to move in the substantially oscillating motion.

21. The method of claim 8, further comprising selecting at least one of the following: metal powder type, metal powder size, metal powder shape, compaction pressure, sintering time, sintering temperature, sintering pressure, atmospheric conditions or any combination thereof, such that a desired porosity is obtained in the formed fishing lure.

22. The method of claim 8, further comprising at least one of the following:
injecting a fish attracting material into at least a portion of a body of the fishing lure;
impregnating at least a portion of the body of the fishing lure with fish attracting material;
soaking at least a portion of the body of the fishing lure with fish attracting material;
or any combination thereof.

23. The method of claim 8, further comprising forming at least one slot, bore or orifice extending at least partially into a body of the fishing lure.

24. A fishing lure manufactured from a sintered metal powder comprising at least one of the following: iron, copper, nickel, chromium, tin, zinc, molybdenum, magnesium, tungsten, aluminum, brass, bronze, stainless steel, carbon steel or any combination, alloy or mixture thereof, the fishing lure comprising a body having a first side surface, a second side surface and an edge surface, wherein at least one of the first side surface, the second side surface and the edge surface comprise at least one undulation sufficient to cause the lure to move in a substantially oscillating motion when urged through the water, wherein the fishing lure has a weight sufficient to sink to a depth in water.
